(19) United States
(12) Patent Application Publication
(10) Pub. No.: US 2025/0340424 A1
(43) Pub. Date: Nov. 6, 2025

(54) DEVICES, SYSTEMS, AND METHODS FOR DISPENSING FLUID PRODUCTS

(71) Applicant: WONDERFIL, PBC, Santa Cruz, CA (US)

(72) Inventors: Amelia EICHEL, Santa Cruz, CA (US); Shiloh SACKS, Santa Cruz, CA (US); Roman REGGIARDO, Santa Cruz, CA (US); Samuel RITZO, Santa Cruz, CA (US)

(21) Appl. No.: 18/871,024

(22) PCT Filed: Jun. 5, 2023
(86) PCT No.: PCT/US2023/024418

§ 371 Date: Dec. 2, 2024

Related U.S. Application Data
(60) Provisional application No. 63/349,110, filed on Jun. 5, 2022.

(51) Int. Cl. B67D 1/12; B67D 1/10; B67D 7/16; B67D 7/32

(52) U.S. Cl. CPC B67D 1/12; B67D 1/10; B67D 7/16; B67D 7/32

(57) ABSTRACT

The following disclosure relates to a system for dispensing fluid. The system includes: a positive displacement pump configured to extract fluid from a reservoir and transfer the fluid toward a dispenser: a flow meter configured to measure a volume of the fluid extracted by the positive displacement pump from the reservoir and transferred toward the dispenser; and a controller configured to compare a volume associated with a rate of displacement of the positive displacement pump with the measured volume of fluid by the flow meter. The controller is also configured to determine whether a difference between the volume associated with the rate of displacement of the positive displacement pump and the measured volume of fluid dispensed from the system via an outlet of the dispenser is less than a predefined threshold such as to provide an accurate volume of dispensed fluid from the system.

The present patent document claims the benefit of U.S. Provisional Patent Application No. 63/349,110, filed Jun. 5, 2022, which is also hereby incorporated by reference in its entirety.

### FIELD

The following disclosure relates to systems, devices, and methods for dispensing, measuring, identifying, and/or processing fluid products (e.g., bulk fluid products).

### BACKGROUND

With consumers increasingly prioritizing environmental friendliness, bulk fluid products are emerging as a top trend in the consumer industry.

Typically, products such as consumer fluids for consumption (e.g., sodas, water, juices, and the like) and personal care products (e.g., lotions, body washes, shampoos, and similar items) are distributed in single-use plastic containers. Despite the growing availability of recycling options, a significant number of these plastic containers remain unrecycled or improperly disposed. Additionally, when deposited in landfills or inadequately discarded, it can take over 450 years for a plastic bottle to decompose. Consequently, the disposal of single-use plastic containers has a significant environmental impact.

The manufacturing process of single-use plastic containers raises various concerns. Projections suggest that by 2040, plastics will be the primary driver of fossil fuel demand. Additionally, plastic production has been linked to air pollution, and studies have documented an increased incidence of cancer among individuals living near plastic manufacturing facilities.

Various methods have been explored to provide refillable options for fluid products. Previous approaches have involved reusable versions of a pre-packaged container that can be dropped off in a certain location to be picked up, sanitized, and refilled. Alternatively, some methods utilize scales to measure the weight of a container before and after a user dispenses product from a bulk container into their smaller container, and users are charged based on the weight difference. However, each of these methods has its own drawbacks.

For example, in a refill system where users must purchase pre-filled reusable containers configured to be returned, sanitized, and refilled, users are limited in terms of how much product they can buy at one time and which reusable container they can use. Additionally, replacing single-use plastic bottles with reusable pre-packaged alternatives may introduce additional steps into the production process that add to an environmental footprint.

Similarly, refill systems relying on pre-dispensing and post-dispensing weighing methods have various drawbacks. This approach involves multiple additional steps that both consumers and retail employees must follow before completing the dispensing process. Consequently, the process becomes time-consuming and labor-intensive.

Furthermore, accuracy is a crucial requirement for scalable refill systems due to government or other standardized requirements (e.g., Weights and Measures) in various jurisdictions.

What is needed, therefore, is a system and method that modernizes and integrates these functions in a unique way that technologically solves these issues, so the user may select a desired amount of his/her fluid product, and the system and method handle certain processing and/or checkout functions automatically.

### SUMMARY

In one embodiment, a system for dispensing a fluid is provided. The system includes a positive displacement pump in fluid communication with a reservoir and a dispenser. The positive displacement pump is configured to extract the fluid from the reservoir and transfer the fluid toward the dispenser. The system also includes a flow meter in fluid communication with the positive displacement pump. The flow meter is configured to measure a volume of the fluid extracted by the positive displacement pump from the reservoir and transferred toward the dispenser. Additionally, the system includes a controller in communication with the positive displacement pump and the flow meter. The controller is configured to compare a volume associated with a rate of displacement of the positive displacement pump with the measured volume of fluid by the flow meter. The controller is also configured to determine whether a difference between the volume associated with the rate of displacement of the positive displacement pump and the measured volume of fluid dispensed from the system via an outlet of the dispenser is less than a predefined threshold such as to provide an accurate volume of dispensed fluid from the system or output a warning when the difference is greater than the predefined threshold.

In another embodiment, a refill station is provided. The refill station includes a plurality of dispensing systems and at least one controller. Each dispensing system includes a reservoir configured to store a fluid and a dispenser configured to dispense the fluid via an outlet of the dispenser. Each dispensing system also includes a positive displacement pump in fluid communication with a reservoir and a dispenser. The positive displacement pump is configured to extract the fluid from the reservoir and transfer the fluid toward the dispenser. Each dispensing system also includes a flow meter in fluid communication with the positive displacement pump. The flow meter is configured to measure a volume of the fluid extracted by the positive displacement pump from the reservoir and transferred toward the dispenser. The at least one controller is configured to compare a volume associated with a rate of displacement of the positive displacement pump with the measured volume of fluid by the flow meter. The controller is also configured to determine whether a difference between the volume associated with the rate of displacement of the positive displacement pump and the measured volume of fluid dispensed from the system via an outlet of the dispenser is less than a predefined threshold such as to provide an accurate volume of dispensed fluid from the system or output a warning when the difference is greater than the predefined threshold.

In another embodiment, a method for dispensing a fluid is provided. The method includes extracting, by a positive displacement pump of a dispensing system, a fluid from a reservoir and transferring the fluid toward a dispenser. The positive displacement pump being in fluid communication with the reservoir and the dispenser. The method also includes measuring, by a flow meter of the system, a volume of the fluid extracted by the positive displacement pump from the reservoir and transferred toward the dispenser. The flow meter being in fluid communication with the positive displacement pump. The method also includes comparing, by a controller of the system, a volume associated with a rate of displacement of the positive displacement pump with the measured volume of fluid by the flow meter. Additionally, the method includes determining, by the controller of the system, whether a difference between the volume associated with the rate of displacement of the positive displacement pump and the measured volume of fluid dispensed from the system via an outlet of the dispenser is less than a predefined threshold such as to provide an accurate volume of dispensed fluid from the system or output a warning when the difference is greater than the predefined threshold.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of a system for dispensing a fluid.

FIGS. 2A-2C depict embodiments of a dispenser of the system for dispensing a fluid.

FIG. 3 depicts a cross-sectional view of a reservoir of the system for dispensing a fluid.

FIG. 4 depicts a detachable refill connector.

FIG. 5 depicts an example of a dispensing process of the system for dispensing fluid.

FIG. 6 depicts an example of a monitoring process of the system for dispensing fluid.

FIG. 7 depicts an example of a verification process of the system for dispensing fluid.

FIG. 8 depicts an example of a system including a plurality of dispensing systems.

FIG. 9 depicts an example of a simplified control circuitry diagram.

FIG. 10 depicts an exemplary system for controlling operation of a dispensing system.

FIG. 11 depicts an exemplary kiosk of the system of FIG. 10.

FIG. 12 illustrates an exemplary server of the system of FIG. 10.

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

The devices, systems, and methods described herein provide solutions to dispensing bulk fluid products that may be stored in a reservoir. The devices, systems, and methods described herein may accurately dispense bulk fluid products into any container a user (e.g., customer, operator, or the like) desires. Specifically, the devices and systems herein are capable of dispensing small volumes of fluids (e.g., less than 5 liters, less than 1 liter, less than 500 ml, less than 100 ml, less than 10 ml) or volumes of fluids within a certain dispensing rate (e.g., within a rate of 0-5 liters per minute, 0-2 liters per minute, 0-1.5 liters per minute, etc.) to a defined level of accuracy required by certain protocols or thresholds (e.g., Weights and Measures protocols).

The devices, systems, and methods described herein may include a positive displacement pump in fluid communication with a reservoir and a dispenser. The positive displacement pump is configured to extract the fluid from the reservoir and transfer the fluid toward the dispenser. The system may also include a flow meter in fluid communication with the positive displacement pump. The flow meter is configured to measure a volume of the fluid extracted by the positive displacement pump from the reservoir and transferred toward the dispenser. Furthermore, the system may include a controller in communication with the positive displacement pump and the flow meter. The controller is configured to receive data from the positive displacement pump and the flow meter. The controller is further configured to confirm the volume of fluid extracted by the positive displacement pump from the reservoir and transferred toward the dispenser based on the data received from the positive displacement pump and the flow meter.

The devices, systems, and methods disclosed herein may be advantageous in their ability to accurately dispense bulk fluid products to users. A user is charged for a volume of fluid product dispensed from a reservoir and is accurately charged without the use of a scale. In other words, the system and method disclosed herein reduce the risk of dispensing too little or too much product to users, therefore preventing underpayment or overpayment.

Additionally, or alternatively, the devices, systems, and methods herein may monitor the various dispensing of the liquid products to charge the consumer for the dispensed product, trigger alerts regarding the remaining bulk product, and assist with monitoring and managing inventory and other features.

The devices, systems, and methods disclosed herein may be advantageous in reducing theft or loss of sales in the sale of the fluid products due to the automatic printing of a label identifying the specific fluid product dispensed. In other words, the system and method disclosed herein may reduce or eliminate the risk of a user mislabeling the dispensed good (e.g., with a lower-priced bulk item or with an incorrect, lower volume). Furthermore, by automatically generating a label for the fluid product, the system and method are advantageous in speeding up the purchase process for the consumer and the store. For example, the consumer may spend a shorter amount of time retrieving and labeling the fluid product at the system for dispensing fluid. Additionally, the scanning of the label at checkout may be advantageously faster than a store employee having to look up a code for a liquid product and volume the item (e.g., like the checkout of a consumer item). Alternatively, the devices, systems, and methods may allow a user or operator of the dispensing system to dispense and pay for fluid product at the dispensing system itself, bypassing any printout label or scanning process at a checkout counter.

The devices, systems, and methods disclosed herein may be advantageous in that a user of a system for dispensing a fluid can fill any container that has an opening large enough to receive the dispensed product. In other words, the user does not have to buy or use a specific container but can use any generic container to refill with a desired fluid product, thus maintaining environmental sustainability.

### Definitions

As used herein, a “fluid” may refer to any material that is capable of flowing and is not solid. A fluid may refer to a gas or liquid composition. In certain examples disclosed herein, a fluid may refer to any liquid composition including creams and/or lotions.

As used herein, a “reservoir” may refer to any storage device configured to store or hold various items such as fluid products (e.g., creams, lotions, and/or liquids). Examples of a reservoir may include fluid containers, fluid cans, fluid tanks, and the like. In certain examples, the reservoir is an airtight container configured to store and protect the fluid product from external contaminants.

As used herein, a “positive displacement pump” may refer to a pump configured to operate by using a mechanism to displace or move fluid from an inlet to an outlet. Positive displacement pumps work by trapping a fixed volume of fluid and then forcing it into the discharge pipe (e.g., through an outlet).

As used herein, a “flow meter” may refer to a device used to measure the rate of flow or quantity of a fluid (liquid or gas) passing through a specific point in a system.

As used herein, an “actuator” may refer to a component configured to respond to a control signal (e.g., from a kiosk or a controller) to initiate dispensing of a fluid product.

As used herein, a “potentiometer” may refer to a variable resistor configured to control the flow of electric current.

As used herein, a “detachable refill connector” may refer to a device or component that allows for easy connection and disconnection of a reservoir to a fluid dispensing system. A detachable refill connector may be configured to provide a secure and reliable connection while allowing for convenient refilling or replenishment of the reservoir.

As used herein, a “display” may refer to an electronic display screen, such as a liquid crystal display (LCD), light emitting diode (LED) display, or any other method of displaying information about the items being dispensed from the reservoirs, such as a “real-time” read-out of the amount (e.g., volume and/or cost) of bulk fluid product dispensed from a dispenser of a fluid dispensing system. A display may be positioned adjacent to each dispensing system. Alternatively, or additionally, a display may be a part of a central hub or kiosk. In certain examples, the display associated with a system for dispensing fluid may be a (e.g., capacitive) touchscreen display or include a (e.g., capacitive) touchscreen interface.

As used herein, a “graphical user interface” or “GUI” may refer to a visual interface that allows users to interact with electronic devices, software, or applications through graphical elements such as icons, buttons, menus, and windows. In certain examples, the GUI may include a capacitive touchscreen interface.

A “label” or “receipt” may refer to a tag or sticker generated by a controller or printer associated with a fluid dispensing system's controller or kiosk that identifies an article (e.g., bulk fluid product) that has been dispensed from the system for dispensing fluids. The label may be configured to be optically scanned at a checkout counter or transmitted via a connected network to a paperless or virtual checkout counter. For example, the label may include a barcode such as a universal product code (UPC), international article number (IAN) code, or stock keeping unit (SKU) code. Alternatively, the label may be a type of matrix barcode, such as a quick response (QR) code. In other embodiments, the label or receipt may include a smart label such as a radio-frequency identification (RFID) configured to be scanned or captured via radio waves. In yet other embodiments, the label or receipt may include a printout or alpha-numeric identification for a particular article (e.g., a specific fluid product), which is configured to be entered or processed at checkout.

As used herein, a “displacement/step” or a “gram/step” or a “mass/step” value is defined as a mass (e.g., as measured in grams), of a fluid dispensed or displaced per step of a pump.

As used herein, a “step” is a defined rotation amount of the positive displacement of a pump.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

### Dispensing Devices and Systems

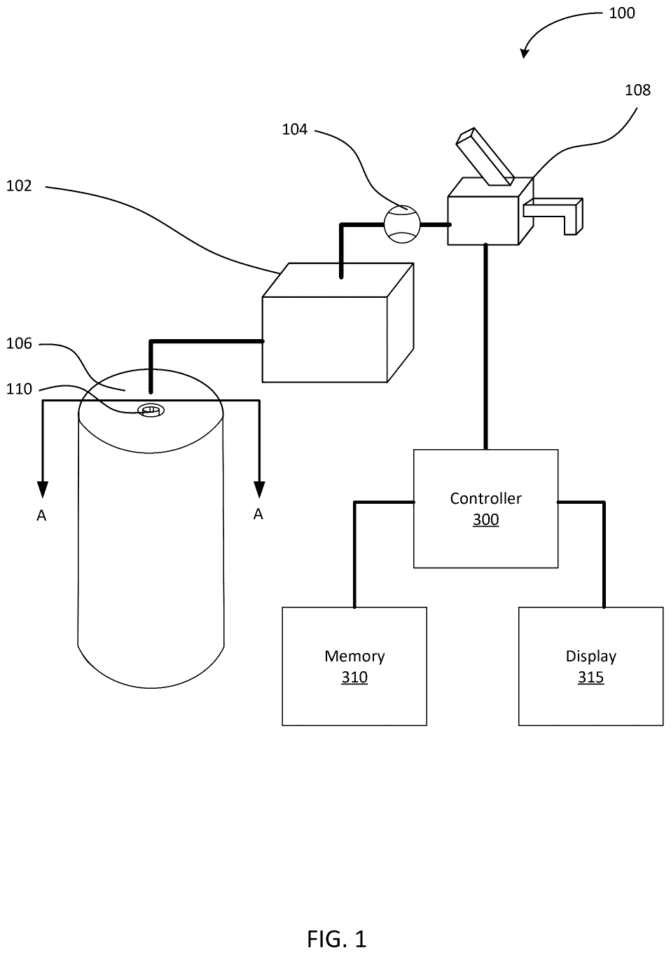

FIGS. 1-4 depict example embodiments of devices and systems for dispensing a fluid. In certain examples, the system may include one or more components of the following: a reservoir, a pump, a flow meter, a dispenser, a sensor, a controller, a memory, and a display. The system advantageously calculates a volume of fluid dispensed by a user and records and/or transmits the total volume dispensed without the need of a scale (e.g., load scale, weight scale, or the like). The fluid dispensed by the system may be any kind of fluid, (including, but not limited to drinks, condiments, personal care products, or cleaning products), that may be stored in bulk in a container/reservoir.

FIG. 1 depicts an example of a system for dispensing a fluid 100. The system 100 includes a positive displacement pump 102, a flow meter 104, a reservoir 106, a dispenser 108, a sensor 112, a controller 300, a memory 310, and a display 315. In this example, the positive displacement pump 102 is in fluid communication with the reservoir 106 and a dispenser 108 via a tube or conduit. The positive displacement pump 102 is configured to extract a fluid from the reservoir 106 via the connected tube/conduit and transfer the fluid toward the dispenser 108. In certain examples, the tube or conduit may be a silicone tubing (e.g., food-grade silicone tubing).

The positive displacement pump 102 may be a peristaltic pump, however the positive displacement pump 102 is not limited thereto and may be any sort of positive displacement pump. Positive displacement pumps, such as peristaltic pumps, may be advantageous in being able to extract and transfer the fluid via a connected tube or conduit without having any pump component come into direct contact with the transferred fluid. In other words, various positive displacement pumps such as peristaltic pumps are advantageous for dispensing a liquid or cream because the pump's internal mechanisms never make contact with the product, only the tubing. Additionally, positive displacement pumps, in combination with the motor drivers of the pumps, may advantageously allow for dispensing fluids with widely ranging viscosities.

In certain examples, the positive displacement pump (e.g., peristaltic pump) includes a motor and motor controller configured to receive input from the controller to operate the pump. Positive displacement pumps such as peristaltic pumps may be controlled by an included stepper motor pulse rotary system. A peristaltic pump moves a substance when a defined number of steps is given to the motor controller. The stepper motor and its accompanying driving mechanism move in “steps” that are created with each modulated pulse to the motor driver. Because each step creates a controlled and reproducible movement of the pump head, understanding the exact amount of substance moved with each input and step allows for precise measurement of an amount dispensed. In certain examples, the accuracy of the positive displacement pump or peristaltic pump (i.e., the measured reading of the pump in comparison with an actual amount of dispensed fluid) may be greater than 99%, or greater than 99.5%.

As noted above, the positive displacement pump 102 is in communication with a motor controller of the pump as well as the controller 300 of the dispensing system such that the controller 300 can control a rate of displacement, speed, rotation, and/or step of the positive displacement pump 102 when a user initiates dispensing of the fluid within the system 100. For example, when a user begins using the dispensing system, the user may move a handle of the dispenser or press a button/actuator. The controller may receive the input and translate the signal to a motor control signal. The controller may output the motor control signal to the motor controller of the pump, thereby instructing the motor controller to begin operation of the pump motor.

The system 100 also includes a flow meter 104 in fluid communication with the positive displacement pump 102. The flow meter 104 is configured to measure a volume of the fluid extracted by the positive displacement pump 102 from the reservoir 106 and transferred toward the dispenser 108. In certain examples, the flow meter 104 may be a calorimetric flow meter that measures the flow rate using calorimetry; however, the flow meter 104 may be any flow meter or sensor used to measure the flow rate of fluid. Such a calculation advantageously provides that the fluid product is moving when the system 100 is dispensing, that the product is moving in the correct direction, and that the product is moving at the expected flow rate. If the flow rate is abnormal, the flow meter 104 can adjust its output such that the abnormal flow rate is properly recorded or provide a notification to the controller 300 of an error in the fluid flow rate measurement. The nonlinear output sensitivity of such a calorimetric flow meter also may advantageously protect system accuracy and purity because the flow meter may be able to detect small changes in product movement (in either direction), thereby allowing a processing device or controller operably coupled to the flow meter to quickly determine and alert the user or operator of a potential system issue.

Additionally, the flow meter 104 is in communication with the controller 300 to transmit the measured flow rates to the controller 300. For example, during a tampering event, such as a user inserting an item into a nozzle/faucet 116 of the dispenser 108, the flow meter 104 may detect product leaking out of the nozzle 116 due to unexpected movement of product during a time where no product should be dispensed, e.g., the positive displacement pump 102 has not been engaged. The duration of the unexpected flow can be recorded, processed, and transmitted, such as to the controller 300.

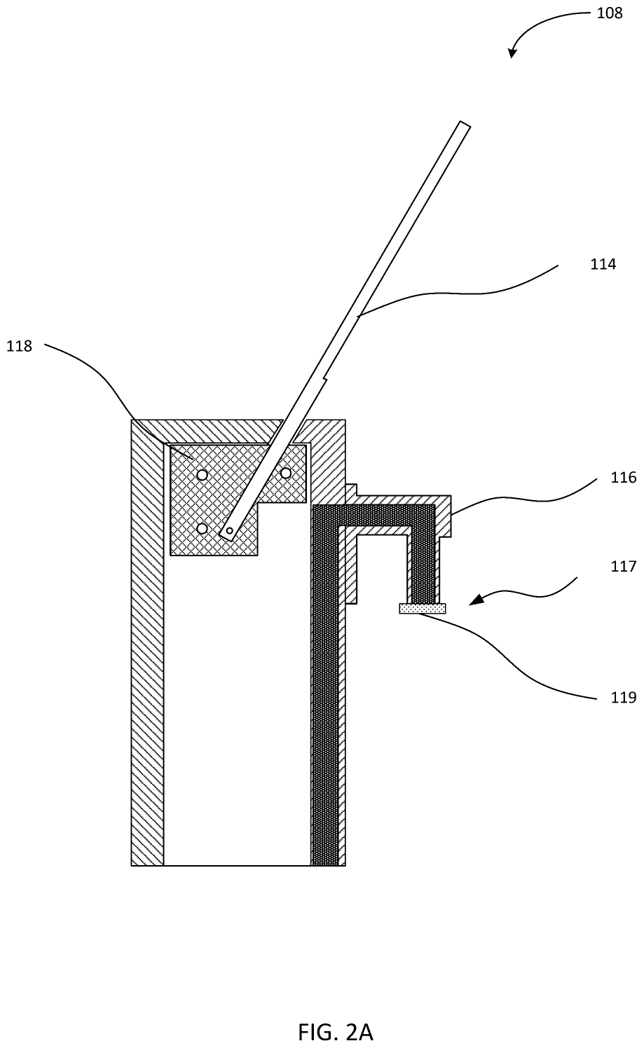

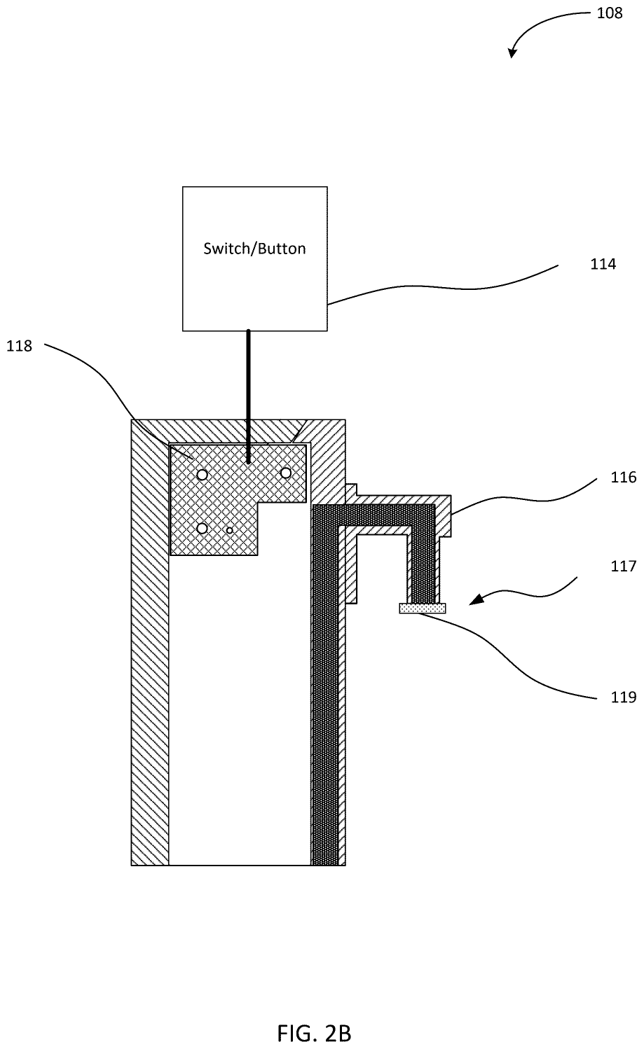

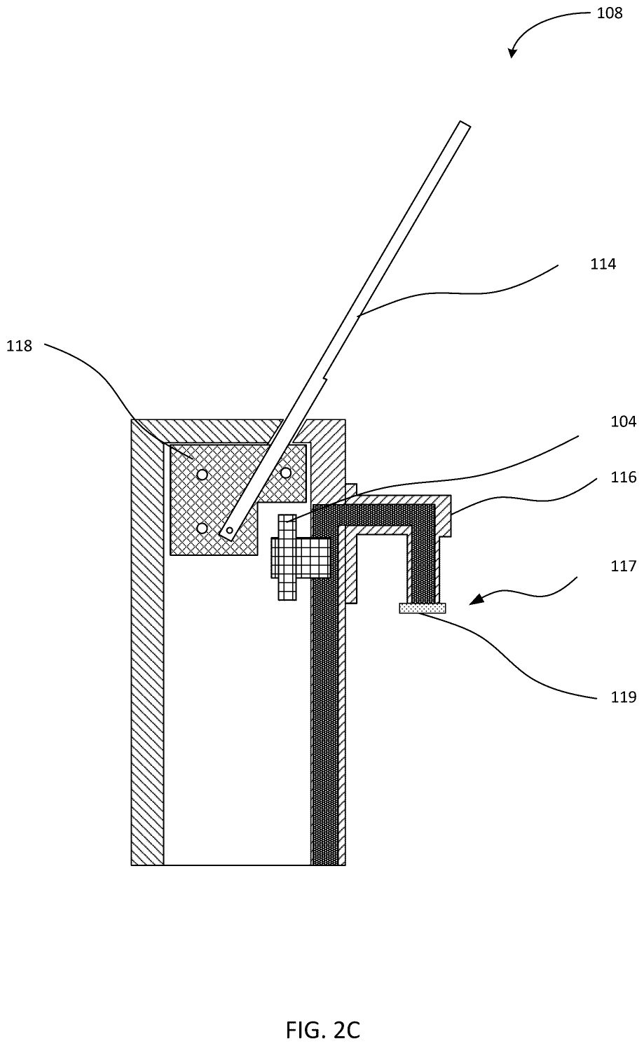

The flow meter 104 may be positioned anywhere within the system 100 between the reservoir 106 and an outlet of the dispenser 108. In the illustrated example in FIG. 1, the flow meter 104 is positioned between the positive displacement pump 102 and the dispenser 108. Alternatively, the flow meter 104 may be positioned between the reservoir 106 and the positive displacement pump 102. In yet other examples, the flow meter 104 may be attached to the dispenser 108 itself (as depicted and described below in FIG. 2C). In some examples, it may be advantageous to have the flow meter 104 positioned as close to an outlet of the dispenser 108 as possible to accurately record the flow rate of the fluid being dispensed at the outlet. In other words, by positioning the flow meter 104 near the dispenser 108 outlet, it can effectively detect any issues within the system 100 prior to the fluid reaching the outlet of the dispenser.

In certain examples, the flow meter may have a high sensitivity capable of measuring low flow rates within a range of 0-5 liters per minute, 0-2 liters per minute, or 0-1.5 liters per minute, having an accuracy of measurement of at least 95%, at least 98%, or at least 99% at a temperature within a range of 0-70° C.

In certain examples, the flow meter may be used to verify a cleaning of the dispensing system. For example, after a period of time or operation of the dispensing system, or at a time of changing out the type of fluid being dispensed, the lines or tubes within the system may be cleaned. In this cleaning process, the lines may be flushed with a cleaning solution (e.g., water and/or isopropyl alcohol). The flow meter may be configured to monitor the flow of fluid through the lines. With an understanding of the viscosity of the fluid being cleaned out and the viscosity of the cleaning solution, and a measurement of the speed of the product passing through the lines, the flow meter may be able to identify when the fluid has been fully cleaned out. That is, a correlation between viscosity and speed may allow the flow meter to identify if the fluid is being transferred through the lines, if a mixture of fluid/cleaning solution is passing through, or if only the cleaning solution is being transferred through the lines (i.e., the lines are clean).

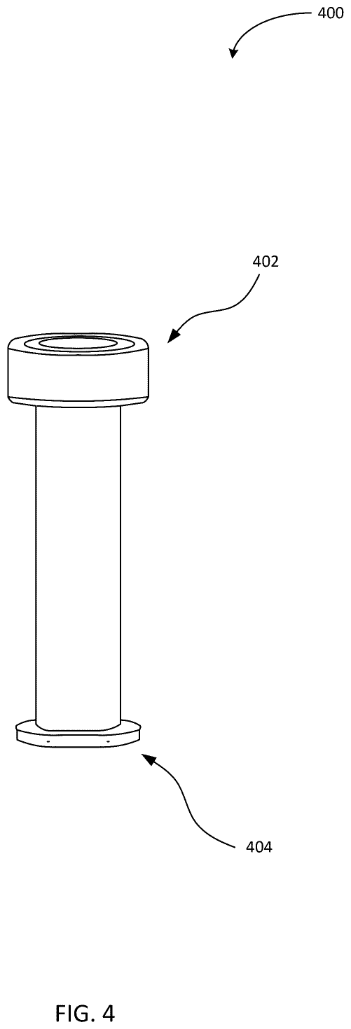

The reservoir 106 is configured to store fluid. The reservoir 106 may include a receiving port 110 (e.g., one-way check valve) positioned on a surface of the reservoir 106. The receiving port 110 (e.g., (one-way check valve) is configured to receive additional fluid into the reservoir from an external source. A detachable refill connector 400 may be used to transfer the additional fluid from the external source to the reservoir 106. The detachable refill connector 400 is further described below with reference to FIG. 4.

In certain examples, the reservoir 106 and/or the external source may include a label (e.g., bar code, QR code, NFC tag, RFID tag, etc.) that is configured to be scanned or otherwise read by the system, wherein the system (e.g., a controller or processor of the system) is configured to interpret the data contained within the label. The information stored within the label may be encoded or configured in a format compatible with the dispensing system. In this way, information regarding the fluid product information, such as a description of the product, cost of the product per weight or volume, and/or a viscosity of the product is input into the memory or database of the system for further processing.

The dispenser 108 may be fluidly connected to the positive displacement pump 102 via the same conduit or tube connected to the reservoir or a separate conduit or tube.

FIG. 2A depicts an embodiment of the dispenser 108. Referring to FIG. 2A, the dispenser 108 includes an actuator 114, the nozzle 116, and a potentiometer 118. For example, in this illustration of the dispenser 108, the actuator 114 is a lever or handle. The handle of the dispenser includes a spring-loaded handle connected to a potentiometer 118.

The actuator 114 is configured to initiate the dispensing of the fluid from the system 100 via an outlet 117 of the dispenser 108. The nozzle 116 includes a self-actuating (e.g., cross-slit) valve 119 configured to seal the outlet 117 and minimize the fluid from dripping out of the nozzle 116 when the system 100 is not dispensing. Additionally, the potentiometer 118 is in communication with the actuator 114 and the controller 300. As the handle is moved by a user, the potentiometer 118 detects the movement and translates the movement into a control signal for the controller 300. In other words, the potentiometer 118 is configured to provide an indicated level of actuation to the controller 300 via a control signal such that a rate of displacement of the positive displacement pump 102 may be based on the level of actuation of the actuator 114.

In certain examples, the potentiometer is configured to output an electrical signal that corresponds to the current position of the attached handle. In an initial back position (e.g., a resting position), the output of the potentiometer is zero (or another value that indicates the system is not in a dispensing state). As the handle is moved forward, the output of the potentiometer changes accordingly (e.g., the handle position as shown in FIG. 2A is in a fully dispensing forward position). For example, as the potentiometer moves, an associated resistance increases (e.g., between about 0.0 and 5 k Ohm). This resistance causes a voltage drop in an input signal. By measuring the difference between the input voltage and an output signal voltage, the controller or a processing device or other similar calculating device can determine the internal resistance of the potentiometer and thus the position of the handle. When a user releases the handle, the spring-loaded rotary potentiometer can automatically return the handle to the back resting position.

The controller can be operably coupled to the potentiometer and configured to receive the output signal. Based upon the voltage level of the signal, the controller can generate a motor control signal such that the positive displacement pump operates in response to the movement of the handle, thereby causing dispensing of the bulk liquid as described herein.

FIG. 2B depicts another embodiment of the dispenser 108 of the system 100.

In this embodiment, the actuator 114 may be a switch, button, or an input on a graphical user interface (GUI) that is in communication with the dispenser 108. The switch, button, or GUI input may be configured to receive an input from a user to initiate and/or stop the dispensing. For example, the user may flip a switch or press a button to commence and/or stop the dispensing of the fluid. In some instances, the user may be able to press the button multiple times to speed up the rate of dispensing. Alternatively, the switch or button may be configured to trigger the dispensing of the fluid at a single rate. In other examples, the GUI may be configured to receive input from a user and transmit a signal to the controller 300 such that the controller 300 controls the rate of displacement of the positive displacement pump 102. Additionally, the GUI may be a display unit. Thus, a user may toggle or actuate an icon on the GUI to initiate the dispensing, stop the dispensing, and/or control the rate of dispensing. Additionally, or alternatively, the user may specify, via the GUI, an amount (e.g., total cost or total volume) of the product they want to dispense.

FIG. 2C depicts another embodiment of the dispenser 108 of the system 100. In this embodiment, the flow meter 104 may be positioned near the outlet 117 of the dispenser 108. Furthermore, FIG. 2C depicts the embodiment of the dispenser wherein the actuator is a lever, however any combination of the embodiments of the dispenser described above may be possible. As mentioned above, it may be advantageous to have the flow meter 104 near the outlet 117 of the dispenser 108 to accurately record the flow rate of the fluid being dispensed.

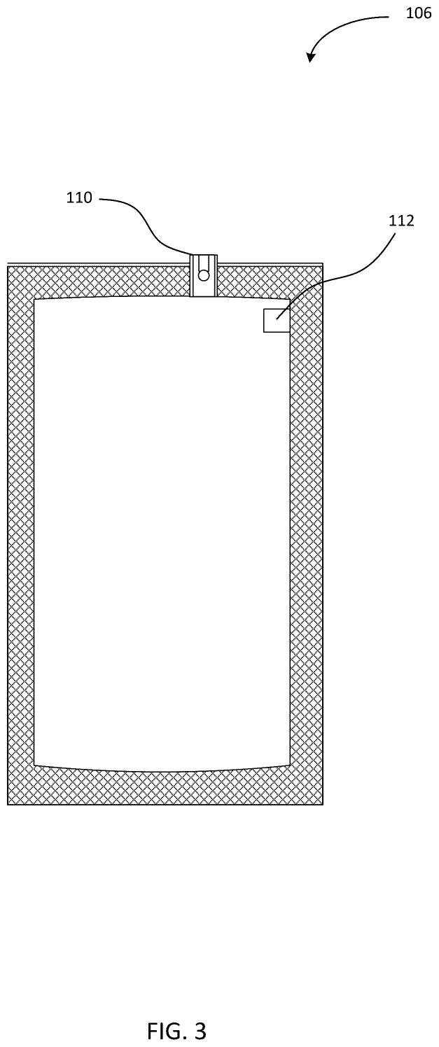

Referring back to FIG. 1, the system 100 also includes one or more sensors 112 positioned within the reservoir 106. FIG. 3 depicts a cross-sectional view, along line A-A, of the reservoir 106 illustrated in FIG. 1 to depict the sensor 112 in the reservoir 106. Referring to FIG. 3, a sensor of the one or more sensors 112 may be configured, in conjunction with the connected controller, to monitor a level of the fluid in the reservoir 106 and/or a rate of depletion of the fluid in the reservoir 106 over a period of time. In certain examples, the sensor may be configured to transmit a signal to the controller over a connected network (either wired or wireless) to provide information about the level of fluid within the reservoir. The signal may also include a time stamp associated with the monitored level. The controller may subsequently be configured to calculate a rate of depletion using two or more data points (i.e., measured level readings at different times) received from the sensor.

In certain examples, the sensor 112 may be calibrated prior to installation or periodically during the lifetime of operation of the system to provide or continue to provide an accurate measurement of the fluid level. In some examples, the sensor 112 may be configured to monitor the fluid level within an accuracy of +/−20 mm, +/−10 mm, or +/−5 mm.

In certain examples, the sensor 112 may be an ultrasonic sensor, however, any suitable sensor may be used to monitor the level of fluid in the reservoir 106 and/or a rate of depletion of the fluid in the reservoir 106 over a period of time. It should be noted that an ultrasonic level sensor is product-agnostic and can advantageously sense levels regardless of the characteristics of the bulk liquid being measured. Additionally, an ultrasonic sensor may advantageously be configured to operate for a long period of time and within a wide temperature range without being serviced or replaced.

Furthermore, in this illustrated example, the sensor 112 is positioned near the top surface of the reservoir. However, the sensor 112 may be positioned anywhere in the reservoir 106 and is not limited to its position depicted herein.

Additionally, or alternatively, a sensor may be positioned within the reservoir to monitor a temperature of the reservoir. In some examples, temperature monitoring is needed to confirm that the fluid dispensing system is being operated under acceptable conditions. For instance, if the temperature is too cold or too hot, the positive displacement pump and or flow meter may not be able to monitor the rate of fluid flow as accurately as compared to doing so at a more suitable temperature or temperature range.

In certain examples, temperature sensors may be positioned or placed strategically throughout the system, such as near each product's flow path, within an electronics enclosure (e.g., near the controller), and/or near/within the reservoirs. If one or more temperature sensors identifies/transmits a reading outside of a predefined operating range for a defined period of time, the controller may transmit an alert to an operator, and depending on the temperature and length of exposure, the system may become out of order.

In further examples, a sensor may be configured to measure additional operating conditions such as pressure and/or altitude. Again, such operating conditions may be needed to be monitored to confirm whether or not the system is operating under acceptable conditions. Alternatively, such information may be used to adapt the system and its associated parameters and/or characteristics such that the accuracy of measuring the dispensed fluid is substantially maintained.

In further examples, a sensor may be positioned within the system (e.g., within the reservoir) and configured to measure a viscosity of the fluid. The sensor's measured viscosity to be transmitted to the controller for further processing. In some examples, the measured viscosity could be compared with an input viscosity by the user/operator of the system to confirm the accuracy of the sensor measurement and/or the input information. An alert could be triggered if the two values differ by a predefined threshold amount (e.g., a difference greater than 1%, greater than 5%, greater than 10%, etc.). In other examples, the measured viscosity could be used in the retrieval of a displacement/step value from a look-up table stored in a memory or database within the system, as described in greater detail below. For example, a look-up table may store a correlation between types and/or viscosities of fluids and displacement/step values associated with the respective types and/or viscosities of fluids. With a known/developed correlation between viscosity and displacement/step values, the sensor's measured viscosity can assist in defining the displacement/step value, in some cases, without any further input from the user or operator of the system. Further, the measured viscosity could change over time (e.g., due to a fluctuation in operating temperature). With an on-going or occasional viscosity measurement, an adjustment could be made with regard to the current operating displacement/step value for the fluid.

The one or more sensors 112 may be configured to communicate with the controller 300 such as to transmit the measured level of fluid and/or the operating conditions (e.g., temperature, pressure, altitude, etc.) in the reservoir to the controller 300.

As a result, the controller 300 is configured to monitor and alert a user or operator of the level of fluid in the reservoir 106 or the operating conditions of the reservoir 106.

For example, an individual fluid product in the reservoir 106 may be defined to be low or out of stock when the sensor 112 detects the fluid level to be below a particular threshold level (e.g., less than 25% of the total volume of the reservoir, less than 20%, less than 15%, less than 10%, or less than 5%). For example, the sensor 112 may be configured to transmit a signal to the controller 300 of the measured level. The controller 300 may process the measured level and alert or provide a notification to an operator of the level of fluid in the reservoir 106. In some examples, when the fluid level is below the defined threshold level, the notification or alert to the user or operator may include a request to refill the reservoir 106.

Additionally, or alternatively, when the sensor identifies a fluid level below a threshold level, the controller may automatically process or order additional fluid product without user interaction. This may be advantageous in maintaining a consistent supply of product within the reservoir prior to total depletion of the fluid. In certain examples, the threshold level to reorder fluid may be the same or different as the threshold level to refill the reservoir. For example, the threshold level to automatically order additional fluid product may occur at 25%, while the threshold level to provide a notification to an operator to refill the reservoir may occur at 10%.

In some examples, the controller, in communication with the sensor, may be configured to monitor a rate of depletion of the fluid in the reservoir. Tracking the level of the fluid over a period of time may advantageously provide more accurate information on a time at which the reservoir may be empty. In other words, based on the rate of depletion, the controller may be able to provide an alert or warning to a user or operator to refill the reservoir by a certain time or by a certain day before becoming empty. Additionally, or alternatively, the controller may be configured to automatically reorder additional fluid product in advance of the predicted time or day the reservoir will be empty. In other words, this automatic reorder time may be different than the time of reorder simply by monitoring the level in the fluid. For example, if the rate of depletion is fairly fast, a trigger to automatically reorder new product may need to occur earlier than the defined threshold level discussed above (such as when the fluid level is at 50%, for example). Alternatively, if the rate of depletion is fairly slow, a trigger to automatically reorder new product may need to occur later than the defined threshold level discussed above (such as when the fluid level is at 5% or 10%, for example).

In another embodiment, the system 100 may include a detachable refill connector 400. FIG. 4 depicts the detachable refill connector 400 configured to receive additional fluid and transfer the additional fluid to the reservoir 106. The detachable refill connector 400 is configured to connect at a first end 402 to the receiving port (e.g., one-way check valve) of the reservoir 106 and is configured to connect at a second, opposite end 404, to an external source (not illustrated), thus creating a fluid connection between the reservoir 106 and the external source to transfer fluid from the external source to the reservoir 106, e.g., via gravity.

The refill connector 400 may be connected via any number of different mechanisms to the reservoir 106 and to the external fluid source, such as a pouch or other fluid receptacle. In one example, the first end 402 of the connector 400 may be screwed onto the opening of the reservoir to provide the connection. At the opposite end 404 of the connector 400, an additional screw connection may be possible between the connector 400 and the external source. This advantageously may provide a closed connection wherein the transfer of fluid from the external source into the reservoir (e.g., via gravity) through the receiving port (e.g., one-way check valve) will not be exposed to an external element or contaminant. Additionally, this process may be advantageous in being able to refill the reservoir without having to disconnect or otherwise move the reservoir from its dispensing position/location. Further, the external source (e.g., pouch) used to refill the reservoir may be configured to be reused or cleaned after each refill process, therein further reducing unnecessary waste associated with the dispensing system.

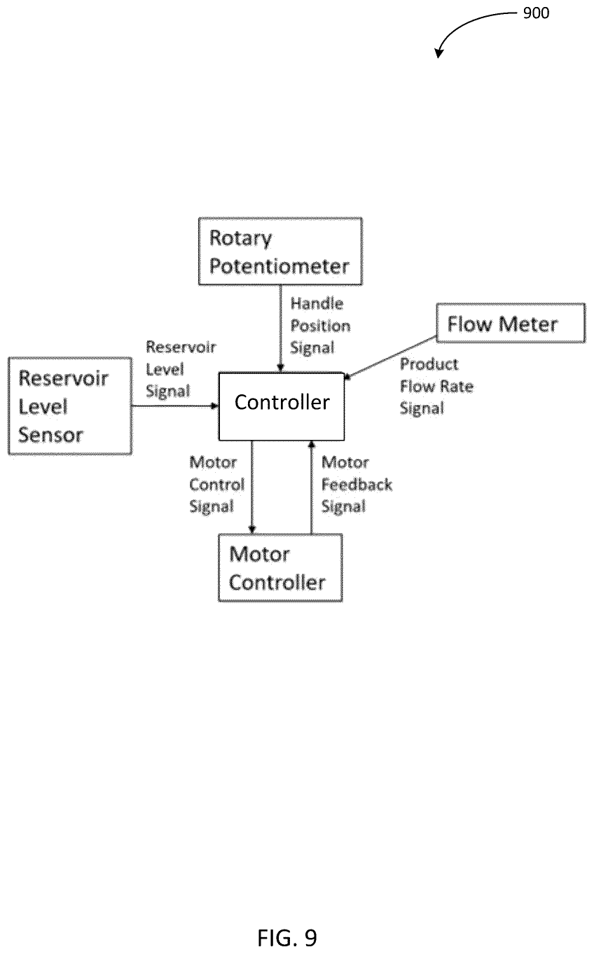

Referring back to FIG. 1, the system 100 includes the controller 300, a memory 310, and a display 315. The controller 300 of the system 100 is configured to be in communication with the positive displacement pump 102, the flow meter 104, the sensor 112, and the potentiometer 118. In other words, the controller 300 may be configured to receive transmission signals from the sensor in the reservoir identifying a fluid level, from the potentiometer indicative of a position of an actuator, from the flow meter identifying a flow rate, and/or from the positive displacement pump identifying a displacement/step of the pump. Further, the controller 300 may be configured to transmit a signal to a motor controller of the positive displacement pump to provide input on how fast or slow to pump (i.e., based on input received from the actuator/potentiometer). A non-limiting example of such a circuitry arrangement is discussed in further detail below with reference to FIG. 9.

For example, when a user initiates the dispensing of a fluid, the positive displacement pump 102, the flow meter 104, the sensor 112, and the potentiometer 118 transmit data to the controller 300, which then processes the data and controls the positive displacement pump 102 to accurately dispense the liquid into a customer's container. The positive displacement pump 102, the flow meter 104, the sensor 112, and the potentiometer 118 may be connected to the controller 300 via a wired or wireless connection. The wireless connection may be any known or later developed wireless network connection such as a wide area network (WAN) (e.g., cellular), local area network (LAN) (e.g., Wi-Fi or IEEE 802.11), or personal area network (PAN) (e.g., Bluetooth or ANT+).

The controller 300 may be configured to receive an input from a user or operator defining a displacement/step value of the fluid, a type of fluid being dispensed, and/or a viscosity of the fluid being dispensed. Additionally, in certain examples, the controller may retrieve the displacement/step value of the fluid based on a description/definition of the fluid or a known viscosity of the fluid from a look-up table stored in the memory 310 further described below.

As mentioned above, the controller 300 is in communication with the positive displacement pump 102 and may be configured to control a rate of displacement of the positive displacement pump 102 based on the measured level of actuation of the actuator 114. For example, as a customer initiates dispensing of a fluid product, the potentiometer 118 transmits a signal to the controller 300, and the controller 300 controls a rate of displacement of the positive displacement pump 102 based on the signal received from the potentiometer, as described above.

Additionally, as mentioned above, the controller 300 is in communication with the flow meter 104 such that any measured flow of fluid leaving the dispenser 108 is measured by the flow meter 104 and transmitted to the controller 300. The controller 300 processes the measured flow rate to determine the volume of fluid being dispensed or leaving the dispenser 108.

The controller 300 may also confirm the volume of fluid extracted by the positive displacement pump 102 from the reservoir 106 and transferred toward the dispenser 108 based on the data received from the positive displacement pump 102 and the flow meter 104.

Specifically, to confirm the volume of fluid extracted and transferred toward the dispenser 108, the controller 300 compares a volume of fluid associated with a rate of displacement of the positive displacement pump 102 with the measured volume of fluid by the flow meter 104. The rate of displacement of the positive displacement pump 102 is based on the displacement/step value associated with the fluid.

Furthermore, the controller 300 determines whether a difference between the volume associated with the rate of displacement of the positive displacement pump 102 and the measured volume of fluid dispensed from the system 100 via the outlet 117 of the dispenser 108 is within a predefined threshold such as to provide an accurate volume of dispensed fluid from the system 100. The predefined threshold may be defined as a margin of error or an accuracy limit. That is, the difference between the rate of displacement and measured flow at the flow meter is within a defined range or margin of error. In other words, the difference or margin of error between the two values is less than 5%, less than 1%, less than 0.5%, or less than 0.1%. Alternatively described, the predefined threshold may be greater than 95%, greater than 99%, greater than 99.5%, or greater than 99.9% accurate. In certain examples, the predefined threshold may be set as dictated or defined by certain regulatory agencies, such as Weights and Measures.

In certain examples, when the difference between the rate of displacement and measured volume of fluid dispensed is below the predefined threshold, the controller 300 may be configured to stop dispensing and/or output an alert or notification to the customer or operator of the system 100 of the potential error in measurement. This advantageously ensures that no customer is receiving and/or being charged for an incorrect volume of product.

The pseudo-algorithm provided below identifies one non-limiting example of how the controller 300 may operate to monitor and compare information received from the positive displacement pump and the flow meter.

Algorithm $1. Integrated Step-Frequency Input to Pump and Flow Meter Output

| | |
|---|---|
| 1: | Flow Meter Output Data (v), Pump Motor Frequency (f), time (t) and Pump Steps (s) |
| 2: | procedure PRODUCT METERING (v, f, s) |
| 3: | |
| 4: | Flow Meter baseline value v ≤ 0.3 |
| 5: | while not in Dispensing State do |
| 6: | if v(t) ≥ 0.4 and t ≥ 2,000 then |
| 7: | site partners notified |
| 8: | if v(t) ≥ 0.4 and [symbol] ≥ 10,000 then |
| 9: | tap out of order |
| 10: | |
| 11: | while in Dispensing State do |
| 12: | if v(t) ≥ 0.35 and v == f(s) then |
| | $\int \text{?}$ |
| 13: | Display Metering Output Value in fluid oz |
| 14: | if v(t) [symbol] = f(s) and v(t) ≥ f(s) and s ≥ 6,000 then |
| 15: | Flow Meter Sensing More Flow than expected, given the input to the pump |
| 16: | No Metering Displayed and Tap out of order |
| 17: | Site Partner and Cloud Partner Alert |
| 18: | |
| 19: | if v(t) [symbol] = f(s) and v(t) ≤ f(s) and s ≤ 3,000 then |
| 20: | Flow metering not sensing less product that is expected, given the input to the pump |
| 21: | No Metering Displayed and Tap out of order |
| 22: | Site Partner and Cloud Partner Alerted |
| 23: | |
| 24: | If the user stops engaging with the lever, presses “Done” on the CUI, or dispenses 32 fl |
| | oz, exit dispensing state |

[symbol]

indicates data missing or illegible when filed

As shown in the algorithm, the process includes two main states: Dispensing and Not Dispensing. When not dispensing, the controller monitors the system for any errors. Depending upon the error detected, the controller can notify an operator or site partner (e.g., if inventory levels are low) or provide a notification that the system is out of order (e.g., if the inventory is below a threshold or there is some other detected error). When dispensing, the controller may monitor various variables and accordingly control the system. For example, if a flow rate above the baseline value is detected, the controller, via the algorithm, may monitor and measure a dispensed product for a time period and display a metered output value (e.g., in fluid ounces, milliliters, or other volumetric measurement unit). If during dispensing, the flow meter and pump motor frequency variables do not match the expected values, the algorithm determines that the product is dispensing an unexpected amount of product (either above or below expectations) and stops the dispensing process. The algorithm further includes steps for notifying a site/cloud partner of the malfunction and indicating that the system is out of order.

The controller 300 may further monitor the system 100 and or verify that the system 100 is not compromised. For instance, the controller 300 may retrieve a stored record of the volume of dispensed fluid from the system 100 for each dispensing event. The controller 300 may then compare a current volume of dispensed fluid with the retrieved record, such as to verify that the system 100 is not compromised. Such monitoring is not only used to determine consistent dispensing of fluid but may be used to determine environmental stability (e.g., ensure there are no leaks in the system and/or that the reservoir is leaking or otherwise compromised) over time. Additionally, monitoring the product levels can provide security to ensure that there is no external tampering with the products contained within the reservoir 106.

Furthermore, the controller 300 may collect additional information that can be used (by the controller 300 itself or by a remotely located computing device) to provide additional information such as system information (including, e.g., system uptime, system use time, product dispensing statistics, and other information), inventory information, user demographic information, and other collected information. The information may be stored in the memory 310 (described further below) and transmitted to be displayed by the display 315 (described further below).

For example, the information can be analyzed, by the controller 300, to determine when product refills are needed, a schedule for product refill ordering and delivery, predictive/future ordering and product use models, and other similar information.

The memory 310 or database may be configured to store a look-up table including a correlation between types and/or viscosities of fluids and displacement/step values associated with the respective types and/or viscosities of fluids. Such a look-up table or data providing a correlation between a type/viscosity of a specific fluid and displacement/step value may be developed through calibration of the positive displacement pump with a particular fluid. In one particular example, the calibration process may include pipetting a specific volume of fluid (e.g., one milliliter of fluid) and measuring the mass/weight of the fluid (e.g., in grams) using a calibrated, high-precision scale. Then, the positive displacement pump may be primed with the fluid product and given a repeated series of specified speeds and steps. A measurement, in grams, of the amount of fluid product dispensed per input may be recorded. These measurements may then be used to determine the displacement/step or mass/step value for the specific fluid (i.e., the amount (e.g., grams) of fluid product dispensed per step of the positive displacement pump). A fluid's displacement/step may vary slightly depending on viscosities of different fluid products, which is why each product should be calibrated.

In some examples, to the extent the memory 310 or database does not contain a specific calibration or displacement/step value for a specific fluid being introduced into the dispensing system, a correlation or calculation may be conducted to provide an approximate displacement/step value for the fluid. For example, if the viscosity of the fluid is known, an interpolation or extrapolation may be conducted using other known viscosity and displacement/step relationships. That is, a calculation of a displacement/step value for an unknown/uncalibrated fluid may be determined using two or more known correlations between viscosity and displacement/step for other fluids. This interpolation or extrapolation may be a linear or nonlinear interpolation or extrapolation.

Furthermore, the memory 310 may be configured to store the accurate volume of dispensed fluid from the system 100 for each dispensing event, such as to create a record. In other words, the memory 310 may store information for each dispensing event as a record or log. Each dispensing event may be each time a fluid has been dispensed by the system 100.

In certain examples, the memory 310 or database may be stored locally within a computer at the site of the dispensing system. Alternatively, the memory 310 or database (e.g., storing the look-up table) may be positioned remotely from the dispensing system and configured to communicate with the controller of the dispensing system via a connected network. In some examples, the memory or database may be stored or saved remotely within a cloud computing environment.

In either embodiment, whether positioned locally or remotely, the memory or database may be configured to be updated by the operator of the system (e.g., over a connected network configuration). The operator of the system may routinely or sporadically update the database and the stored look-up table with additional or revised information on various fluid products being introduced or included within the dispensing system. In some examples, the operator of the system or the system itself may scan a label (e.g., bar code, QR code, NFC tag, RFID tag, etc.) present on the reservoir or an external source (e.g., a pouch) when a fluid product is introduced into the reservoir. As noted above, in this way, information regarding the fluid product information, such as a description of the product, cost of the product per weight or volume, and/or a viscosity of the product is input into the memory or database of the system for further processing.

In certain examples, the memory or database may store or track information regarding the usage of the dispensing system (i.e., user behavior) over a period of time. The usage information may be transmitted to the controller via one or more of the sensors (e.g., the reservoir sensor) and subsequently stored within the database or memory of the system. The controller or a connected computing device may be used to analyze the usage information to determine when product refills are needed, a schedule for product refill ordering and delivery, predictive/future ordering and product use models, and other similar information. Additionally, a store or other retail location using the dispensing system may access the information to determine station-specific information such as average users, total product dispensed, total cost/profit information, and other various information of interest to a retailer. Using this stored usage information, along with one or more predictive model, an operator or vendor of the dispensing system may advantageously be able to offer accurate and efficient real-time ordering of products to be dispensed in its refill systems and stations. Additionally, by taking advantage of these tracking features, a cloud-based information system may be developed for sharing/distribution of product information for a refill system associated with a particular retailer.

Furthermore, the memory 310 may be a volatile memory or a non-volatile memory. The memory 310 may include one or more of a read only memory (ROM), random access memory (RAM), a flash memory, an electronic erasable program read only memory (EEPROM), or other type of memory.

The display 315 may include a functionality configured to generate a printout or sticker that may be adhered to a user's container after being filled with a volume of dispensed fluid. Such printout or sticker may include relevant information of the dispensed product, such as the amount of product dispensed, a name of the product, ingredients of the product, use instructions for the product, and/or other information related to the product or dispensing thereof

Alternatively, the display 315 may be an electronic display, such as a liquid crystal display (LCD), a light-emitting diode (LED) display, a plasma display, or an electronic-ink display. The advantage of such an electronic display is the configurability to update or change the advertisement or information presented on the display. Furthermore, the display 315 may be a graphical user interface (GUI) such that a user may interact with the display. For instance, the display may be a touch screen display.

The display 315 may display information about the fluid dispensed from the reservoir 106. The information may include a volume (e.g., in ounces or milliliters to the tenths place), a cost (e.g., in dollars to the hundredths place), or both the volume and the cost of the fluid dispensed from the reservoir 106 using the accurate volume of dispensed fluid extracted from the reservoir 106. The information depicted on the display 315 may be depicted in real-time as the user is dispensing the fluid, therein advantageously providing information on when to stop dispensing fluid based on an end target volume or cost. Alternatively, in some examples, the display 315 may be configured to receive input from the user or operator of the dispensing system on the target volume or cost desired prior to commencing with the dispensing of the fluid. In other words, a user may input a desired amount of fluid (volume or cost) and direct the dispensing system (via the display/GUI) to dispense the predefined amount.

The volume and cost of the fluid dispensed are calculated (e.g., in real-time) by the controller 300 based on the provided accurate volume of dispensed fluid. The display 315 may also be configured to display descriptions of the dispensed item, instructions on how to operate the system 100, instructions on calibration, sourcing information of where the bulk fluid item originated, etc. In some examples, the display 315 may be configured to display information relevant to a particular user (i.e., different information specific to a type of user), such as a consumer or an operator/manager of the dispensing system. For example, information displayed to a consumer may include instructions on how to operate or interact with the system 100, information regarding the products available in the system 100, advertisements, and/or other information. Information displayed to an operator or manager of the system may include instructions of how to interact with the system 100, troubleshoot issues with the system 100, settings/configuration information of the system 100 and/or other information of interest or relevance to an operator of the system 100

### Process of Dispensing Fluid

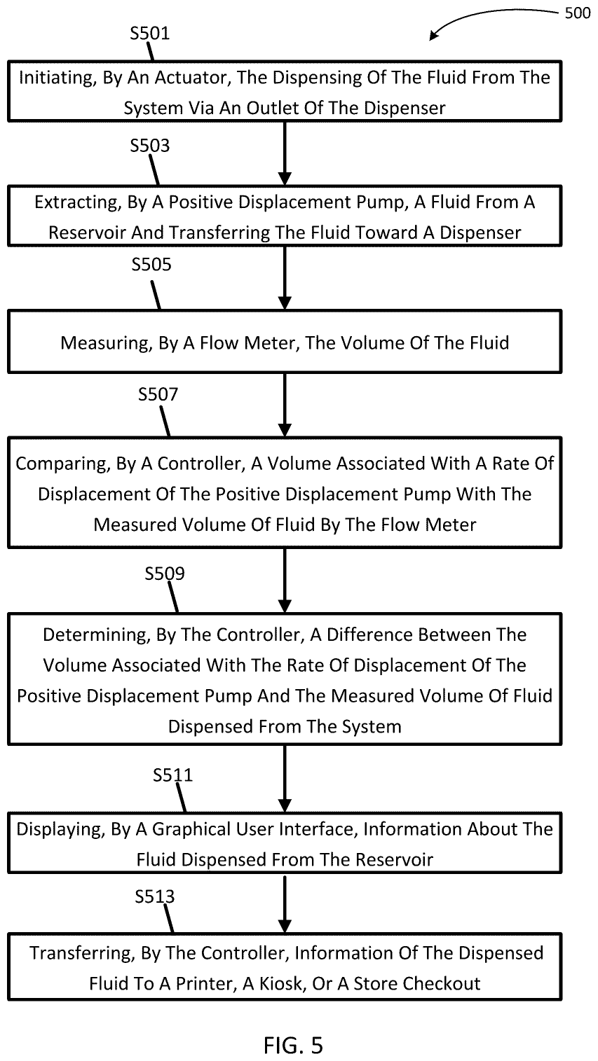

FIG. 5 depicts an example process 500 of dispensing fluid. The process may begin at act S501 by initiating a dispensing of a fluid from the system via the outlet 117 of the dispenser 108. In certain examples, the dispensing of the fluid may be initiated via an actuator (e.g., a handle, button, switch, GUI). Alternatively, the dispensing of the fluid may be initiated via opening a valve. In some examples, a potentiometer 118 of the system 100 may detect movement of the actuator 114 and transmit a signal containing an indicated level of actuation to the controller 300 via a control signal over a wired or wireless connection.

In act S503, the positive displacement pump 102 extracts the fluid from the reservoir 106 and transfers the fluid to the dispenser 108. In some examples, the controller 300 may control the volume of fluid extracted by the positive displacement pump 102 by processing the transmitted measured level of actuation of the actuator 114 and control the rate of displacement of the positive displacement pump based on the level of actuation of the actuator 114. The positive displacement pump 102 may transmit a signal to the controller 300 that includes information regarding the rate of displacement or number of steps by the positive displacement pump 102. The controller 300 may determine a volume amount of fluid extracted using the rate of displacement or number of steps provided to the controller 300, or by other information provided by the positive displacement pump 102. As mentioned above, the rate of displacement of the positive displacement pump 102 is based on a displacement/step value associated with the fluid. In some cases, the displacement/step value for a particular fluid or the type of fluid being dispensed and/or the viscosity of the fluid being dispensed may be directly input by a user or operator. In other examples, the information about a particular fluid may be indirectly input by a user/operator or the system itself by processing a scanning or reading of a label including information about a particular fluid. This may be a label such as a bar code, QR code, NFC tag, RFID tag, etc. that is configured to be scanned or otherwise read by the system, wherein the system (e.g., a controller or processor of the system) is configured to interpret the data contained within the label. The data or information within the label could include a viscosity associated with the particular fluid, which could then be correlated with a displacement/step value within the particular dispensing system. In some cases, the controller 300 may retrieve the displacement/step value using information input about the specific fluid from a look-up table stored in memory 310 of the system 100.

In act S505, the volume of fluid extracted by the positive displacement pump from the reservoir 106 and transferred toward the dispenser 108 is measured by the flow meter 104. In such instances, the flow meter 104 may transmit a signal containing the measured flow rate to the controller 300 over a wired or wireless connection.

In act S507, the controller compares a volume associated with a rate of displacement of the positive displacement pump 102 and the measured volume of fluid by the flow meter 104 to identify if there are any inaccuracies between the two components of the dispensing system.

In act S509, the controller 300 determines whether a difference between the volume associated with the rate of displacement of the positive displacement pump 102 and the measured volume of fluid dispensed from the system 100 via an outlet 117 of the dispenser 108 is less than a predefined threshold such as to provide an accurate volume of dispensed fluid from the system 100. Alternatively, the controller 300 may output a warning when the difference is greater than the predefined threshold. Additionally, the warning may be outputted to an operator of the system 100 when the difference is greater than the predefined threshold. The warning may be displayed on the display 315.

In act S511, the display 315 may display information about the fluid dispensed from the reservoir 106. The information may include a volume, a cost, or both the volume and the cost of the fluid dispensed from the reservoir 106 using the accurate volume of dispensed fluid extracted from the reservoir 106. The cost of the fluid dispensed may be calculated by the controller 300 based on the provided accurate volume of dispensed fluid and a defined cost per unit volume for a specific fluid.

Lastly, in act S513, the controller 300 may transfer a volume, a cost, or both the volume and the cost of the fluid dispensed to a printer (not illustrated), a kiosk, or a store checkout (not illustrated) using the accurate volume of dispensed fluid from the system 100.

### Process of Monitoring the Dispensed System

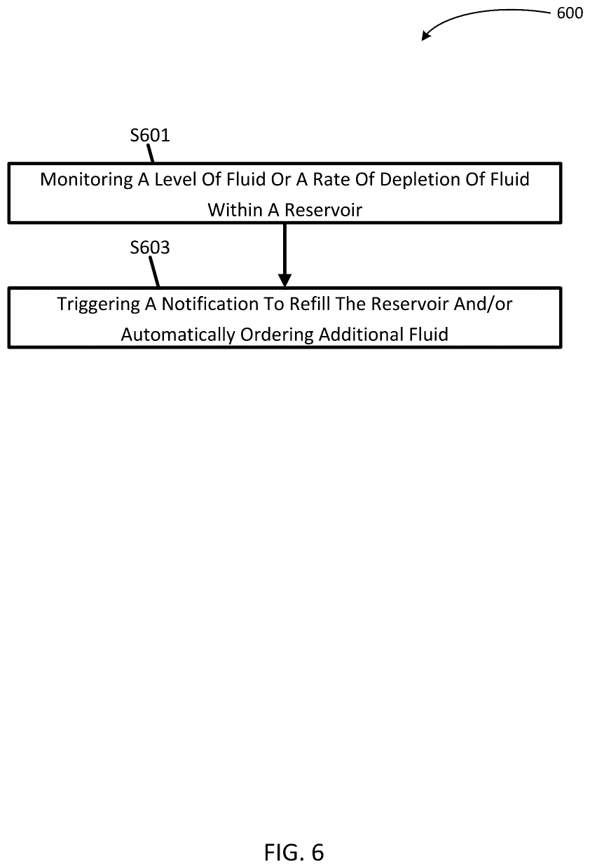

FIG. 6 depicts a monitoring process of the dispensing system 100 in addition to the dispensing process described in FIG. 5. The process may begin at S601 by monitoring a level of the fluid in the reservoir 106 and/or a rate of depletion of the fluid in the reservoir 106 over a period of time. The monitoring may be conducted using one or more sensors in communication with the controller. In an example, a sensor may be positioned within the reservoir 106. The sensor may transmit a signal to the controller over a connected network (either wired or wireless) to provide information about the level of fluid within the reservoir. The signal may also include a time stamp associated with the monitored level. The controller may be configured to calculate a rate of depletion using two or more data points (i.e., measured level readings at different times).

In certain examples, the sensor may be an ultrasonic sensor, however, any suitable sensor may be used to monitor the level of fluid in the reservoir and/or a rate of depletion of the fluid in the reservoir over a period of time.

In act S603, the controller 300 triggers, a notification or alert to refill the reservoir 106 and/or automatically reorder additional fluid based on the monitored level in the reservoir 106 or the calculated rate of depletion of the fluid over the period of time. The alert may be transmitted to a user or operator over a connected network and/or displayed on the display 315.

In certain examples, the alert may be triggered when the level of the fluid within the reservoir reaches or drops below a predefined threshold value (e.g., when the level reaches or drops below 25%, 20%, 15%, 10%, or 5% of the total volume of the reservoir). For example, the sensor may be configured to transmit a signal to the controller of the measured level. The controller 300 may process the measured level and alert or provide a notification to an operator of the level of fluid in the reservoir 106. In some examples, when the fluid level reaches or drops below the defined threshold level, the notification or alert to the user or operator may include a request to refill the reservoir. Additionally, or alternatively, when the sensor identifies a fluid level below a threshold level, the controller may automatically process or order additional fluid product without user interaction. In certain examples, the threshold level to reorder fluid may be the same or different as the threshold level to refill the reservoir.

In some examples, the controller, in communication with the sensor, may track the rate of depletion or the level of the fluid over a period of time, as this may advantageously provide more accurate information on a time at which the reservoir may be empty. The controller may be able to provide an alert or warning to a user or operator based on the calculated rate of depletion over time to refill the reservoir by a certain time or by a certain day before becoming empty. Additionally, or alternatively, the controller may be configured to automatically reorder additional fluid product in advance of the predicted time or day the reservoir will be empty.

In other examples, the controller may be configured to utilize the flow meter data associated with the system to adjust dispense calibrations over time and provide consistent and accurate metering of the dispenser or recognize and alert an operator/manager of the system when that is no longer attainable.

In other examples, the controller and connected network system (discussed in greater detail below) may be configured to track one or more product velocities or product uses based on how quickly one or more dispensing systems at one or more different site locations sells or dispenses each fluid product. This may incorporate a learning algorithm configured to assist in learning based on past dispensing patterns for one or more fluid products to predict how much, when, and where new fluid product is needed in a multi-location dispensing system infrastructure. This may provide advantages in identifying a more accurate consumer demand for product such that fluid product may be automatically ordered and shipped to specific site locations in advance (e.g., shortly in advance) of running out of a specific fluid product at that site location, therein limiting excess inventory being stored on-site, while also limiting or eliminating any downtime or out-of-stock dispensing reservoirs. In other words, this monitoring and learning process by the controller and connected network of a dispensing system may advantageously inform both logistics (how much, when, where inventory is shipped) and purchasing (how much, what kind, when, where inventory is ordered).

### Process of Verifying the Dispensed System

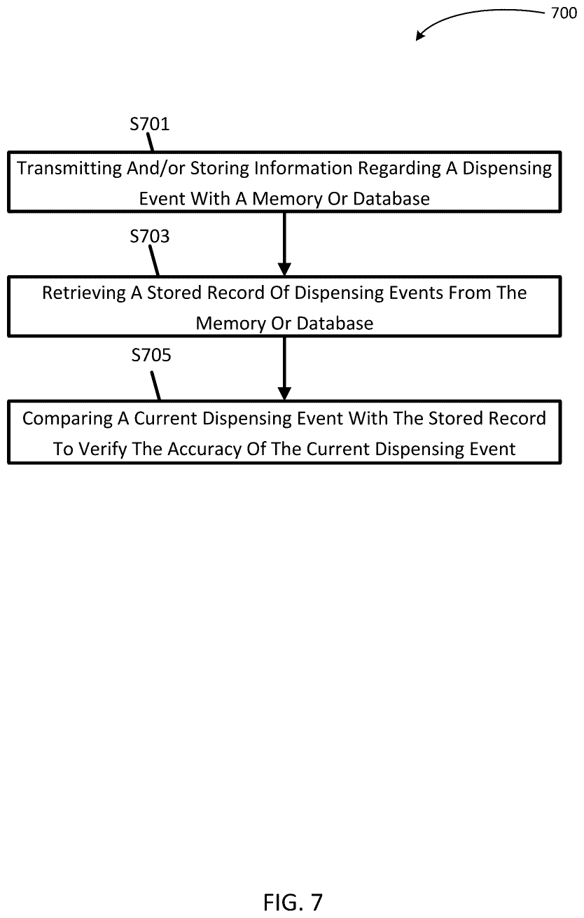

FIG. 7 depicts a verification process of the system 100 in addition to the dispensing process described in FIG. 5. The process may begin at S701 by transmitting information (e.g., an accurate volume of dispensed fluid) to a memory 310 or database for each dispensing event, therein creating a record or log of accurate dispensing events for a system. The transmitted information may be stored within the database or memory 310 of the dispensing system 100, therein creating a record or log of accurate dispensing events for a system. The record may include a stored log of dispensing events and each dispensing event may contain information about the volume of fluid dispensed, the volume of fluid in the reservoir 106, and the flow rate of the fluid dispensing from the dispenser 108. In certain examples, at a conclusion of each dispensing event, the controller may transmit information to the memory or database regarding the event, therein updating the log within the memory or database.

In act S703, the controller 300 of the system 100 may retrieve the stored record from the memory 310 of the system 100.

In act S705, the controller 300 of the system 100, may compare a current dispensing event (e.g., a current volume of dispensed fluid) with the retrieved record such as to verify that the system 100 has not been compromised. The comparison may include verifying that the current dispensing event remains within an operating threshold range from past dispensing events. As mentioned above, this process is advantageous in verifying that the system 100 is not compromised (i.e., no leaks).

Following the comparison, the controller may be configured to transmit a notification to a user or an operator of the system when there is an anomaly with the system 100 (e.g., when the current dispensing event is outside of the defined operating range based on past performance). This transmission or alert may provide information about the potential error, including data regarding the current dispensing event and past performance.

### A Refill Station Having a Plurality of Fluid Dispensing Systems

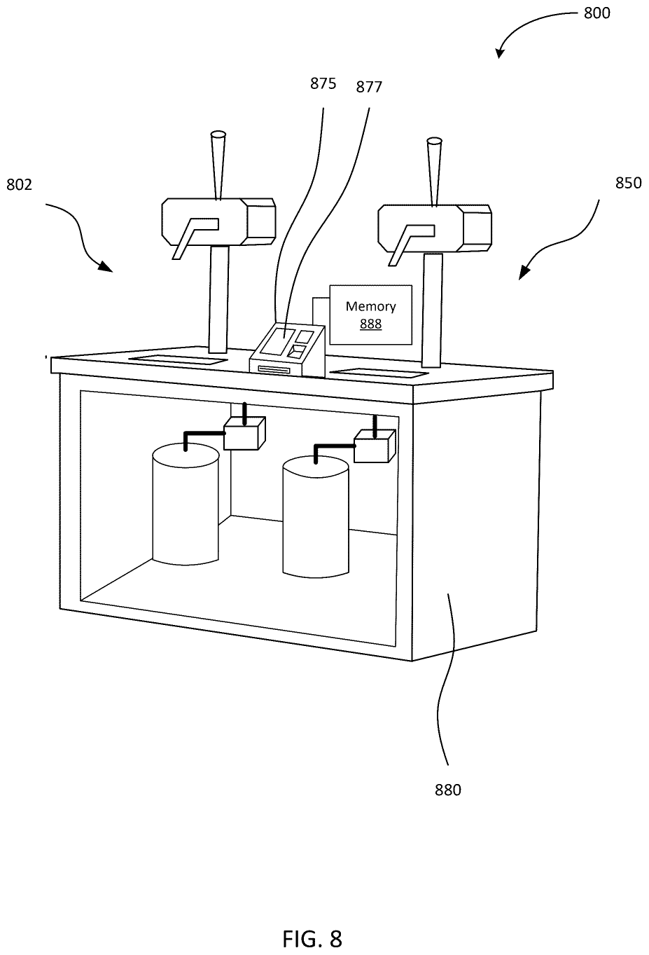

FIG. 8 depicts an example of a refill station 800 including a plurality of dispensing systems (i.e., two or more dispensing systems) 802, 850, at least one controller 875, at least one display 877, and at least one memory 888. Furthermore, in this illustration, a support frame 880 is provided for housing the dispensing systems 802, 850, the at least one controller 875, the at least one display 877, and the at least one memory 888.

Each of the dispensing systems 802, 850, may include a positive displacement pump, a flow meter, a reservoir, a dispenser, and a sensor, wherein the positive displacement pumps, flow meters, reservoirs, dispensers, and sensors may be the same or similar to those components described above with reference to FIGS. 1-3.

Furthermore, within the system depicted in FIG. 8, each reservoir may include receiving port (e.g., one-way check valve) configured to be attached to a detachable refill connector to refill each individual reservoir, as described above in FIG. 4.

As mentioned above, the refill station 800 includes at least one controller 875. The at least one controller 875 may the same or similar to the controller 300 described in the examples above. In this example in FIG. 8, the controller 875 is a central controller that is associated with multiple (i.e., each) dispensing system of the plurality of dispensing systems. In other words, the central controller may receive signals from the various components of each of the dispensing systems 802 and 850 and/or control both of the dispensing systems 802 and 850. Furthermore, the central controller 875 may be in communication with a printer, kiosk, or a store checkout. For example, the central controller 875 may be configured to transmit a signal to the printer, kiosk, or store checkout, wherein the signal includes information regarding a volume, a cost, or both the volume and the cost of the fluid dispensed as monitored/verified by one of the dispensing systems 802, 850 within the overall system or refill station 800.

In another embodiment, the refill station 800 may include a plurality of controllers, wherein at least one controller may support a respective dispensing system 802, 850. For example, the dispensing system 802 may have its own respective controller, and the dispensing system 850 may have its own controller. Each controller associated with a respective individual dispensing system 802, 850 may be in communication with the central controller 875.

Alternatively, while not depicted in FIG. 8, each controller associated with a respective individual dispensing system 802, 850 may be in communication with its own printer, kiosk, or store checkout. In yet another alternative, each controller associated with a respective individual dispensing system 802, 850 may be in communication with a central or shared printer, kiosk, or store checkout.

As mentioned above, the refill station 800 includes at least one display 877 and at least one memory 888. The at least one display 877 and memory 888 may be of a same or similar configuration or combination of embodiments as described above with regards to the display 315 and the memory 310. In certain examples, the display 877 and the memory 888 may be associated with and shared by each dispensing system of the plurality of dispensing systems. In other words, the central display 877 and the central memory 888 may be used for both of the dispensing systems 802 and 850.

In another embodiment, the refill station 800 may include a plurality of displays, and a plurality of memories. Each display and memory may support a section for each respective dispensing system 802, 850. For example, the dispensing system 802 may have its own respective display and memory, and the dispensing system 850 may have its own display and memory.

In certain examples, the memory or memories may be stored locally within a computer at the site of the dispensing system/refill station 800. Alternatively, the memory or memories (e.g., storing the look-up table) may be positioned remotely from the dispensing system 800 and configured to communicate with the controller of the refill station/dispensing system 800 via a connected network. In some examples, the memory or memories may be stored or saved remotely within a cloud computing environment.

In either embodiment, whether positioned locally or remotely, the memory or memories may be configured to be updated by the operator of the system (e.g., over a connected network configuration). The operator of the system may routinely or sporadically update the database and the stored look-up table with additional or revised information on various fluid products being introduced or included within the dispensing system.

### Control Systems for Operating the Dispensing System

FIG. 9 depicts an example of a control circuitry diagram identifying the interaction between a controller or processor of the dispensing system and its surrounding devices. As shown in FIG. 9, the controller or processor may be configured to receive signals from various components of the system, process the signals, and provide output signals such as the motor control signal as well as system output signals to one or more additional devices such as a user interface and/or a remotely located computing device. Specifically, in one non-limiting example, the controller or processor of a dispensing system may be in communication with the positive displacement pump (e.g., a motor controller of the pump), the flow meter, the reservoir sensor, the potentiometer or actuator of the dispenser, and any additional temperature or pressure sensors (not depicted) within the system. In other words, the controller may be configured to receive transmission signals from the sensor in the reservoir identifying a fluid level, from the potentiometer identifying a position of an actuator, from the flow meter identifying a flow rate, or from the positive displacement pump identifying a displacement/step of the pump. Further, the controller may be configured to transmit a signal to a motor controller of the positive displacement pump to provide input on how fast or slow to pump (i.e., based on input received from the actuator/potentiometer).

More specifically, the controller or processor of the dispensing system may be configured to both control the dispensing of the bulk liquid as well as monitor the operation of the system to ensure there are no malfunctions. For example, when a user begins using the dispensing system, the user may move the handle as described above resulting in a handle position signal as output by the rotary potentiometer. The controller may receive the handle position signal and translate the signal to a motor control signal. The controller may output the motor control signal to the motor controller, thereby instructing the motor controller to begin operation of the pump motor. As the pump motor moves the peristaltic pump, resulting in the dispensing of the bulk liquid, the controller may also continually receive a reservoir level signal from the reservoir level sensor, a product flow rate signal from the flow meter, and a motor feedback signal from the motor controller. The controller may further process these signals to determine whether an expected flow rate of the liquid (as determined based upon analysis of the motor input signal) matches the actual flow rate of the liquid being dispensed (as determined based upon analysis of the product flow rate signal). For example, the controller may receive flow rate information from the flow meter for a period of time. Based upon the flow rate information, the controller may calculate a total amount of product dispensed. Concurrently, the controller may determine the amount of product pumped based upon movement information from the motor controller. By comparing each of these measurements, the controller may accurately and precisely determine whether each measurement is correct and how much product has been dispensed. Such a comparison of measurements and related data may act to provide an added level of accuracy and reliability in the system, and further define over the current state of the art dispensing devices that may rely on a single point of measurement.

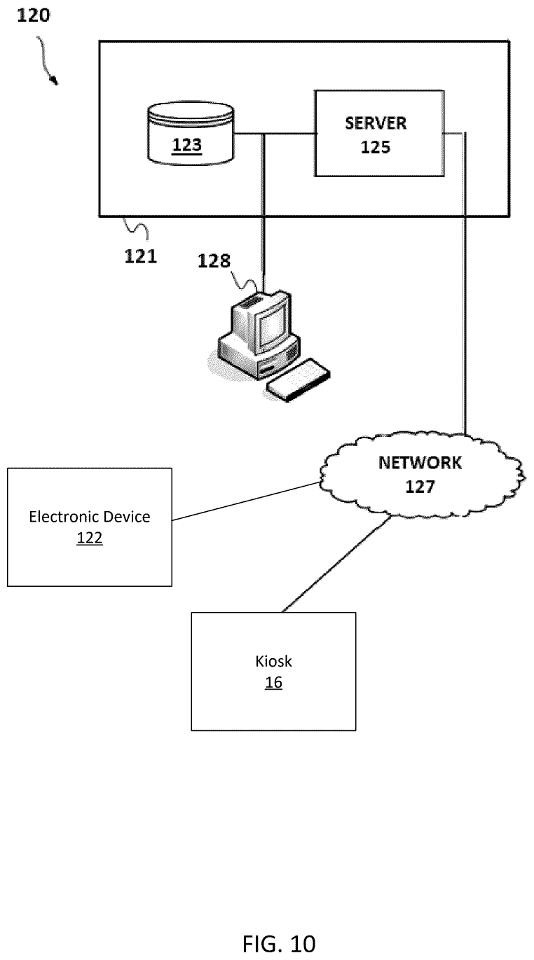

FIG. 10 illustrates an exemplary system 120 for controlling operation of the dispensing system 100 or the refill station 800. The system 120 includes the dispensing system 100 (such as described above in FIGS. 1-4) or the refill station 800 (such as described in FIG. 8), a monitoring system 121, at least one electronic device 122, a workstation 128, and a network 127. Additional, different, or fewer components may be provided. For example, the system 120 may include one or more kiosks 16 in addition to the monitoring system 121.

As noted above, the at least one electronic device 122 may be any computing device such as a workstation, a server, a desktop computer, a tablet computer, a notebook computer, a smart phone, or a mobile phone, for example. The electronic device may include a GUI. The electronic device 122 may include the controller or processor as described above.

In certain examples, the electronic device 122 may be operated by a manager of the dispensing system 100 for a specific location via the connected network 127 (e.g., either at the physical location of the system or remote to the location). Alternatively, the electronic device 122 may be operated by a third-party vendor or supplier of one or more bulk fluids, wherein the vendor may be able to access information over the connected network 127 to monitor the inventory or sales of the one or more bulk fluids being sold at one or more locations being monitored by the system 121. This is advantageous in that the vendor may be able to have real-time information about when a next shipment of a bulk fluids may be required at a specific location. Additionally, the vendor may be able to understand which bulk fluids are selling fast or slow and adjust sales strategies accordingly. This may include canceling the shipment of a specific bulk fluid based on poor sales or requesting an adjustment in price (e.g., a discount) for a poor selling bulk fluids. In certain examples, the vendor may be able to directly adjust the pricing or provide an updated advertisement (e.g., showing a discount) of a bulk fluids via the connected network 127, wherein the vendor provides the updated pricing or advertisement to be displayed on a display screen of a bulk fluid dispensing system or refill station.

In certain examples, the manager of a dispensing system 100 and the third-party vendor/supplier of the dispensing system 100 may be configured to operate respective electronic devices 122 in communication with the dispensing system, wherein each respective party is configured to have different access capabilities or functionalities with information stored within the dispensing system.

The monitoring system 121 includes a server 125 and a database 123. The monitoring system 121 may include computer systems and networks of a system operator (e.g., the operator of the dispensing system 100). The server database 123 or a memory within the server 125 may be configured to store information regarding the various bulk fluids being sold in one or more of the individual systems 100. This information may include historical sales trends, inventories, suppliers, sell-by-dates, and pricing information for each of the bulk fluids being sold. Additionally, or alternatively, the server database 123 or a memory within the server 125 may store a look-up table associated with various fluids within the dispensing system 100 or refill station/dispensing system 800, as discussed above. In certain examples, the server 125 and/or database 123 may be configured to support a plurality of different monitoring systems 121 that are individually associated with a particular operator of one or more bulk fluid dispensing systems. In some examples, the server 125 and/or database 123 may be stored within a cloud computing environment.

The monitoring system 121, the workstation 128, and the at least one electronic device 122 are coupled with the network 127. The phrase “coupled with” is defined to mean directly connected to or indirectly connected through one or more intermediate components. Such intermediate components may include hardware and/or software-based components.

The optional workstation 128 may be a general-purpose computer including programming specialized for providing input to the server 125. For example, the workstation 128 may provide settings for the server 125. The settings may include a value for the predetermined interval that the server 125 requests the device 122 to relay current geographic locations. The workstation 128 may be used to enter data indicative of Global Positioning System (GPS) accuracy to the database 123. The workstation 128 may include at least a memory, a processor, and a communication interface.

In certain examples, the workstation 128 may be a kiosk of the dispensing system 100. Alternatively, the workstation 128 may be a central hub computer that is in communication with a kiosk and an electronic device.

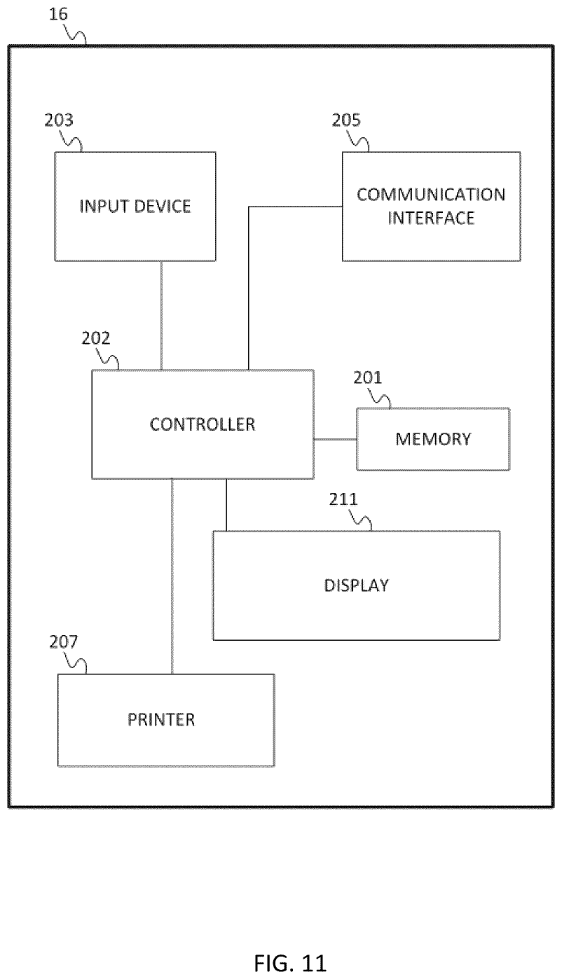

FIG. 11 illustrates an exemplary kiosk 16 of the system of FIG. 10. The kiosk 16 includes a controller 202, a memory 204, an input device 203, a communication interface 205, a printer 207, and a display 211. Additional, different, or fewer components are possible for the kiosk 16. As noted in the examples above, the communication interface 205 may be configured to receive a transmission or signal from a sensor of the dispensing system.

The controller 202 is then configured to interpret the transmission to identify which dispensing system 100 dispensed fluid. The controller 202 may also be configured to interpret from the transmission the volume and/or cost of the bulk fluid dispensed and provide instructions to the printer 207 to print a label (e.g., a barcode or RFID tag) with the identifying information for the dispensed bulk fluid (e.g., the volume, cost, and/or description of the dispensed item). In certain examples, the display 211 of the kiosk 16 may be configured to display information regarding the dispensed bulk fluid, such as the volume, cost, and/or description of the dispensed item. Further, the display 211 may be configured to display additional information related to the dispensed bulk fluid, such as sourcing information of where the bulk fluid item originated. In some examples, the display 211 may be a touch screen display allowing a consumer to interact with the kiosk to learn more information about a particular bulk fluid that has been dispensed.

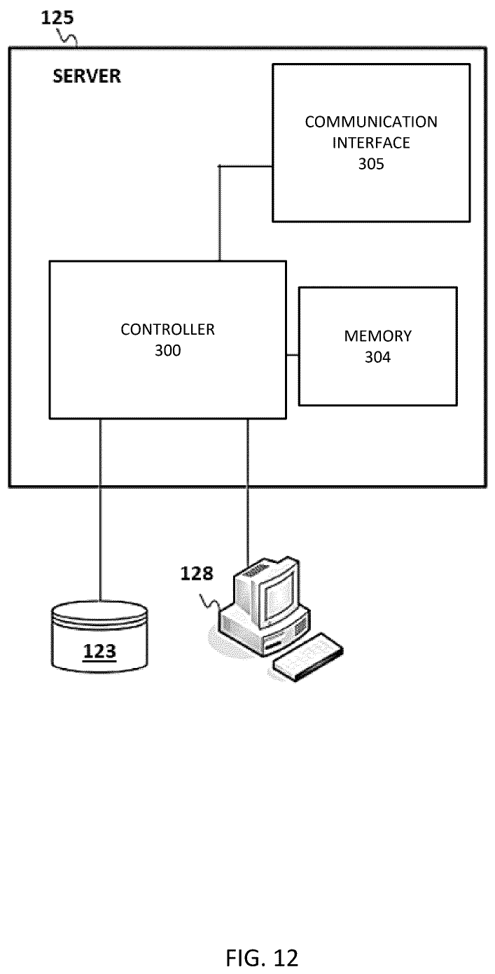

FIG. 12 illustrates an exemplary server 125 of the system of FIG. 10. The server 125 includes a memory 304, a controller or processor 300, and a communication interface 305. The server 125 may be coupled to a database 123 and a workstation 128. The workstation 128 may be used as an input device for the server 125. The communication interface 305 receives data indicative of user inputs made via the workstation 128 or a separate electronic device.

The controller or processor 300 may include a general processor, digital signal processor, an application specific integrated circuit (ASIC), field programmable gate array (FPGA), analog circuit, digital circuit, combinations thereof, or other now known or later developed processor. The controller or processor 300 may be a single device or combination of devices, such as associated with a network, distributed processing, or cloud computing.

The controller or processor 300 may also be configured to cause the system to perform one or more of the method acts described herein. For example, the controller or processor 300 may be configured to control the positive displacement pump 102 based on the actuation of the actuator 114 and received measurements from the flow meter 104 and the sensor 112. The processor or controller 300 may also confirm the volume of fluid extracted by the positive displacement pump 102 from the reservoir 106 and transfer the fluid toward the dispenser 108 based on the data received from the positive displacement pump 102 and the flow meter 104. The controller or processor 300 may further monitor the system 100 and or verify that the system 100 is not compromised. Furthermore, the controller 300 may collect additional information that can be used (by the controller 300 itself or by a remotely located computing device) to provide additional information such as system information (including, e.g., system uptime, system use time, product dispensing statistics, and other information), inventory information, user demographic information, and other collected information. The information may be stored in a memory 304.

The memory 304 (e.g., memory 310 as described above with reference to the dispensing system 100, 800) may be a volatile memory or a non-volatile memory. The memory 304 may include one or more of a read only memory (ROM), random access memory (RAM), a flash memory, an electronic erasable program read only memory (EEPROM), or other type of memory. The memory 304 may be removable from the device 122, such as a secure digital (SD) memory card.

The communication interface 305 may include any operable connection. An operable connection may be one in which signals, physical communications, and/or logical communications may be sent and/or received. An operable connection may include a physical interface, an electrical interface, and/or a data interface. The communication interface 305 provides for wireless and/or wired communications in any now known or later developed format.

In the above-described examples, the network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

While the non-transitory computer-readable medium is described to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting example, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement one or more of the methods described herein. Applications that may include the apparatus and systems of various examples can broadly include a variety of electronic and computer systems. One or more examples described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the claim scope is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having similar functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term “circuitry” or “circuit” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any digital computer. The processor may receive instructions and data from a read only memory or a random-access memory or both. The essential elements of a computer are a processor for performing instructions and one or more memory devices for storing instructions and data. The computer may also include or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., E PROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube), LCD (liquid crystal display), or LED (light emitting diode) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server may be remote from each other and may interact through a communication network. The relationship of client and server arises by virtue of computer programs running on the respective computers and having a client-server relationship with each other.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A system for dispensing a fluid, the system comprising:
a positive displacement pump in fluid communication with a reservoir and a dispenser, wherein the positive displacement pump is configured to extract the fluid from the reservoir and transfer the fluid toward the dispenser, wherein a rate of displacement of the positive displacement pump is based on a displacement/step value associated with the fluid, wherein the displacement/step value is defined as a mass of the fluid dispensed per step of the positive displacement pump, and wherein the step is a defined rotation amount of the positive displacement pump;
a memory configured to store a look-up table comprising a correlation between viscosities of fluids and displacement/step values associated with the respective viscosities; and
a controller in communication with the positive displacement pump and the memory, wherein the controller is configured to:
receive an input defining a type of the fluid or a viscosity of the fluid;
retrieve the displacement/step value of the fluid from the look-up table stored in the memory of the system using the input; and
determine a volume of dispensed fluid from an outlet of the dispenser based on the rate of displacement of the positive displacement pump.

2. The system of claim 1, further comprising:
the dispenser,
wherein the dispenser comprises an actuator configured to initiate the dispensing of the fluid from the system via the outlet of the dispenser.

3. The system of claim 2, wherein the outlet of the dispenser comprises a nozzle having a self-actuating valve configured to seal the outlet and minimize the fluid from dripping out of the nozzle when the system is not dispensing.

4. The system of claim 2, wherein the actuator of the dispenser comprises a graphical user interface (GUI) configured to receive an input from an operator to initiate and/or stop the dispensing.

5. The system of claim 2, wherein the dispenser further comprises a potentiometer in communication with the actuator,
wherein the potentiometer is configured to measure a level of actuation of the actuator, and
wherein the controller is further configured to control the rate of displacement of the positive displacement pump based on a measured level of actuation of the actuator.

6.-7. (canceled)

8. The system of claim 1, wherein the controller is further configured to receive an input defining the displacement/step value of the fluid.

9.-10. (canceled)

11. The system of claim 1, further comprising:
the reservoir configured to store the fluid.

12. The system of claim 11, wherein the reservoir comprises a receiving port positioned on or near a surface of the reservoir, and
wherein the receiving port is configured to receive additional fluid into the reservoir from an external source.

13. The system of claim 12, further comprising:
a detachable refill connector configured to connect at a first end to the receiving port of the reservoir,
wherein the detachable refill connector is configured to connect at a second, opposite end, to the external source to receive the additional fluid and transfer the additional fluid to the reservoir.

14. The system of claim 13, wherein the detachable refill connector is configured to provide a sealed connection between the external source and the reservoir, therein preventing any external contaminants from entering the reservoir during a refill process.

15. The system of claim 1, further comprising:
a sensor positioned within the reservoir, wherein the sensor is configured to monitor a level of the fluid in the reservoir and/or a rate of depletion of the fluid in the reservoir over a period of time.

16. The system of claim 15, wherein the controller is further configured to:
automatically trigger an alert to refill the reservoir and/or automatically reorder additional fluid based on the monitored level in the reservoir or the rate of depletion of the fluid over the period of time.

17. (canceled)

18. The system of claim 1, wherein the positive displacement pump comprises a peristaltic pump.

19. (canceled)

20. The system of claim 1, further comprising:
a graphical user interface (GUI) configured to display information about the dispensed fluid from the reservoir and/or display instructions to an operator of the system on how to dispense the fluid.

21. The system of claim 20, wherein the information comprises a volume, a cost, or both the volume and the cost of the dispensed fluid.

22. (canceled)

23. The system of claim 1, wherein the controller is further configured to transfer a volume, a cost, or both the volume and the cost of the dispensed fluid to a printer, kiosk, or a store checkout.

24. The system of claim 1, wherein the memory is further configured to store the volume of the dispensed fluid from the system for each dispensing event such as to create a record,
wherein the controller is configured to retrieve the record and compare a current volume of dispensed fluid with the record such as to verify that the system is not compromised.

25. A refill station comprising:
a plurality of dispensing systems;
at least one memory configured to store a look-up table comprising a correlation between viscosities of fluids and displacement/step values associated with the respective viscosities; and
at least one controller;
wherein each dispensing system of the plurality of dispensing systems comprises:
a reservoir configured to store a fluid;
a dispenser configured to dispense the fluid via an outlet of the dispenser; and
a positive displacement pump in fluid communication with the reservoir and the dispenser, wherein the positive displacement pump is configured to extract the fluid from the reservoir and transfer the fluid toward the dispenser, wherein a rate of displacement of the positive displacement pump is based on a displacement/step value associated with the fluid, wherein the displacement/step value is defined as a mass of the fluid dispensed per step of the positive displacement pump, and wherein the step is a defined rotation amount of the positive displacement pump,
wherein the at least one controller is configured to:
receive an input defining a type of the fluid or a viscosity of the fluid for a dispensing system of the plurality of dispensing systems; and
retrieve the displacement/step value of the fluid from the look-up table stored in the at least one memory of the refill station for the respective dispensing system using the input; and
determine a volume of dispensed fluid from an outlet of the dispenser of the respective dispensing system based on the rate of displacement of the positive displacement pump for the respective dispensing system.

26.-63. (canceled)

64. The system of claim 1, wherein the determined volume of the dispensed fluid from the system based on the rate of displacement of the positive displacement pump is greater than 99% accurate from an actual volume of the dispensed fluid.

65. The system of claim 4, wherein the input from the operator is an initiation to dispense a specific volume of the fluid.
